(19) United States
(12) Patent Application Publication
(10) Pub. No.: US 2006/0118754 A1
(43) Pub. Date: Jun. 8, 2006

(54) Stabilizing a polyelectrolyte multilayer

(76) Inventor: Daniel C. Lapen, Cambridge, MA (US)

Correspondence Address: PROSKAUER ROSE LLP, ONE INTERNATIONAL PLACE 14TH FL, BOSTON, MA, 02110, US

(21) Appl. No.: 11/007,831

(22) Filed: Dec. 8, 2004

(51) Int. Cl. H01G 9/02; C08J 5/20

(52) U.S. Cl. 252/62.2; 521/25

(57) ABSTRACT

The invention provides methods for sequencing nucleic acids by using a stabilized polyelectrolyte multilayer. Generally, methods of the invention comprise a polyelectrolyte multilayer exposed to an amine-carboxyl reactive cross-linker.

### TECHNICAL FIELD OF THE INVENTION

The invention provides methods for sequencing nucleic acids by using a stabilized polyelectrolyte multilayer. Generally, methods of the invention comprise a polyelectrolyte multilayer exposed to an amine-carboxyl reactive cross-linker.

### BACKGROUND OF THE INVENTION

Completion of the human genome has paved the way for important insights into biologic structure and function. Knowledge of the human genome has given rise to inquiry into individual differences, as well as differences within an individual, as the basis for differences in biological function and dysfunction. For example, single nucleotide differences between individuals, called single nucleotide polymorphisms (SNPs), are responsible for dramatic phenotypic differences. Those differences can be outward expressions of phenotype or can involve the likelihood that an individual will get a specific disease or how that individual will respond to treatment. Moreover, subtle genomic changes have been shown to be responsible for the manifestation of genetic diseases, such as cancer. A true understanding of the complexities in either normal or abnormal function will require large amounts of specific sequence information.

An understanding of cancer also requires an understanding of genomic sequence complexity. Cancer is a disease that is rooted in heterogeneous genomic instability. Most cancers develop from a series of genomic changes, some subtle and some significant, that occur in a small subpopulation of cells. Knowledge of the sequence variations that lead to cancer will lead to an understanding of the etiology of the disease, as well as ways to treat and prevent it. An essential first step in understanding genomic complexity is the ability to perform high-resolution sequencing.

Various approaches to nucleic acid sequencing exist. One conventional way to do bulk sequencing is by chain termination and gel separation, essentially as described by Sanger et al., Proc. Natl. Acad. Sci., 74(12): 5463-67 (1977). That method relies on the generation of a mixed population of nucleic acid fragments representing terminations at each base in a sequence. The fragments are then run on an electrophoretic gel and the sequence is revealed by the order of fragments in the gel. Another conventional bulk sequencing method relies on chemical degradation of nucleic acid fragments. See, Maxam et al., Proc. Natl. Acad. Sci., 74: 560-564 (1977). Finally, methods have been developed based upon sequencing by hybridization. See, e.g., Drmanac, et al., Nature Biotech., 16: 54-58 (1998).

There have been many proposals to develop new sequencing technologies based on single-molecule measurements, generally either by observing the interaction of particular proteins with DNA or by using ultra high resolution scanned probe microscopy. See, e.g., Rigler, et al., DNA-Sequencing at the Single Molecule Level, Journal of Biotechnology, 86(3): 161 (2001); Goodwin, P. M., et al., Application of Single Molecule Detection to DNA Sequencing. Nucleosides & Nucleotides, 16(5-6): 543-550 (1997); Howorka, S., et al., Sequence-Specific Detection of Individual DNA Strands using Engineered Nanopores, Nature Biotechnology, 19(7): 636-639 (2001); Meller, A., et al., Rapid Nanopore Discrimination Between Single Polynucleotide Molecules, Proceedings of the National Academy of Sciences of the United States of America, 97(3): 1079-1084 (2000); Driscoll, R. J., et al., Atomic-Scale Imaging of DNA Using Scanning Tunneling Microscopy. Nature, 346(6281): 294-296 (1990). Unlike conventional sequencing technologies, their speed and read-length would not be inherently limited by the resolving power of electrophoretic separation. Other methods proposed for single molecule sequencing include detecting individual nucleotides incorporated during sequencing by synthesis.

While single molecule techniques have several advantages, implementation has been a problem due to high background signal and the difficulty of preparing surfaces sufficient to enable true signal detection in the single molecule context. Surfaces suitable for nucleic acid detection are a significant issue in sequencing generally and single molecule sequencing in particular. Nucleotides arrayed on a solid surface have been utilized for drug development, DNA sequencing, medical diagnostics, nucleic acid-ligand binding studies and DNA computing. Conventional surfaces for immobilization of DNA include latex beads, polystyrene, carbon electrodes, gold and oxidized silicon or glass. Those surfaces involve chemistries that are not always ideal for oligonucleotide sequencing. A primary difficulty with most conventional surfaces is that they generate significant background signal. When fluorescent detection is used in sequencing, that problem becomes more acute.

As discussed earlier, conventional nucleotide sequencing is accomplished through bulk techniques. Bulk sequencing techniques are not useful for the identification of subtle or rare nucleotide changes due to the many cloning, amplification and electrophoresis steps that complicate the process of gaining useful information regarding individual nucleotides. As such, research has evolved toward methods for rapid sequencing, such as single molecule sequencing technologies. The ability to sequence and gain information from single molecules obtained from an individual patient is the next milestone for genomic sequencing. However, effective diagnosis and management of important diseases through single molecule sequencing is impeded by lack of cost-effective tools and methods for screening individual molecules.

Accordingly, there is a need in the art for methods and devices for sequencing generally, and single molecule sequencing in particular, including surfaces of substrates appropriate for nucleic acid detection and discrimination.

### SUMMARY OF THE INVENTION

The invention provides cross-linked polyelectrolyte multilayer surfaces and methods for nucleic acid sequencing on those surfaces. Methods of the invention generally involve stabilizing a polyelectrolyte multilayer by exposing it to an amine-carboxyl reactive cross-linker. The cross-linker reacts with the multilayer to create a cross-linked polyelectrolyte surface. The cross-linked surface is accessible for attachment of molecules and is highly wash stable. It also has a low susceptibility to non-specific binding due to favorable surface characteristics as described below.

A preferred amine-carboxyl reactive cross-linker according to methods of the invention is 1-ethyl-3(3-dimethylaminopropyl)carbodiimide hydrochloride (EDC). However, other cross-linkers are useful in the invention. In addition, other methods for cross-linking, for example, ultraviolet cross-linking or dehydration cross-linking are contemplated. A polyelectrolyte multilayer is any layered surface comprising alternating positive and negative charged polymeric units. Preferred polymers include Poly(Acrylic Acid) (PAcr), Poly Ethyleneimine (PEI), Poly Allylamine, Polystyrene Sulphonate (PSS), Polylysine, and Polyglutamic Acid. A preferred polyelectrolyte multilayer comprises alternating layers of PAcr and PEI. Polyelectrolyte multilayers are well known and any suitable combination can be used according to the invention.

The invention comprises stabilizing a polyelectrolyte multilayer on a substrate. According to the invention, a polyelectrolyte multilayer is exposed to an amine-carboxyl reactive cross-linker resulting in the stabilization of the polyelectrolyte multilayer on the substrate. The polyelectrolyte multilayer is then ready to be used as a surface for attachment of molecules of interest.

In a preferred embodiment, surfaces of the invention are used for nucleic acid sequencing. Oligonucleotides are attached to a cross-linked surface, either directly or by using a binding pair. A preferred binding pair is biotin/avidin. In that case, initial cross-linking is preferably done in the substantial absence of biotin. After cross-linking of the polyelectrolyte multilayer is complete, biotin or streptavidin is applied to the surface in order to facilitate the attachment of nucleic acid templates on the surface of the substrate. Other binding pairs also are useful as described in detail below.

To determine the sequence of a target nucleic acid template, the target is attached to the surface of a substrate coated with a polyelectrolyte multilayer. Prior to attaching the template, the polyelectrolyte multilayer is stabilized with an amine-carboxyl cross-linker. The attached nucleic acid template is exposed to a primer, polymerase, and at least one nucleotide under conditions that allow for incorporation of the nucleotide into the primer. Incorporation of the nucleotide is detected and the steps of exposing the template to a primer, polymerase, and nucleotide are then repeated in order to compile a sequence of the template.

Target nucleic acids are attached to a surface of the invention by direct or indirect means. Targets may be attached to the surface by a direct amine linkage. Preferably, however, the surface is coated with an attachment molecule during or, preferably, after cross-linking. For example, after cross-linking, the surface can be biotinylated by known methods. Following application of streptavidin, a biotinylated oligo target is bound to the surface for sequencing. Alternatively, streptavidin (or avidin) is incorporated directly into the surface layer, followed by binding of a biotinylated oligo target. Other linkers are known and may be used in the invention. For example, antigen/antibody pairs (e.g., digoxigenin and anti-digoxigenin) are useful.

According to one aspect of the invention, bound target nucleic acid templates are individually optically resolvable on the surface. This allows resolution of sequence at a single molecule level. The sequence reactions comprise introduction of dye-labeled nucleotides to a template-bound primer attached to a cross-linked polyelectrolyte multilayer surface. Nucleotides are incorporated into the primer if they are complementary to the appropriate base on the target. Unincorporated nucleotides are washed away from the surface, and incorporated nucleotides are imaged. A cross-linked surface according to the invention has superior stability and resistance to degradation or template dislodging during the wash step.

Nucleotides useful in the invention include any nucleotide or nucleotide analog, whether naturally-occurring or synthetic. For example, preferred nucleotides are adenine, cytosine, guanine, uracil, or thymine bases; xanthine or hypoxanthine, 5-bromouracil, 2-aminopurine, deoxyinosine, or methylated cytosine, such as 5-methylcytosine, and N4-methoxydeoxycytosine. Also included are bases of polynucleotide mimetics, such as methylated nucleic acids, e.g., 2′-O-methRNA, peptide nucleic acids, modified peptide nucleic acids, and any other structural moiety that can act substantially like a nucleotide or base, for example, by exhibiting base-complementarity with one or more bases that occur in DNA or RNA and/or being capable of base-complementary incorporation, and includes chain-terminating analogs.

Nucleotides particularly useful in the invention comprise detectable labels. Labeled nucleotides include any nucleotide that has been modified to include a label that is directly or indirectly detectable. Preferred labels include optically-detectable labels, including fluorescent labels or fluorophores, such as fluorescein, rhodamine, derivatized rhodamine dyes, such as TAMRA, phosphor, polymethadine dye, fluorescent phosphoramidite, texas red, green fluorescent protein, acridine, cyanine, cyanine 5 dye, cyanine 3 dye, 5-(2′-aminoethyl)-aminonaphthalene-1-sulfonic acid (EDANS), BODIPY, 120 ALEXA, or a derivative or modification of any of the foregoing.

In one embodiment, the primer includes a first detectable label and an incorporated nucleotide includes a second detectable label for use in fluorescence resonance energy transfer (FRET) as a detection scheme for determining the base type incorporated into the growing primer. Fluorescence resonance energy transfer in the context of sequencing is described generally in Braslavasky, et al., Sequence Information can be Obtained from Single DNA Molecules, Proc. Nat'l Acad. Sci., 100: 3960-3964 (2003), incorporated by reference herein. Essentially, in one embodiment, a donor fluorophore is attached to one of the primer, polymerase, or template. Nucleotides added for incorporation into the primer comprise an acceptor fluorophore that can be activated by the donor when the two are in proximity. Activation of the acceptor causes it to emit a characteristic wavelength of light and also quenches the donor. In this way, incorporation of a nucleotide in the primer sequence is detected by detection of acceptor emission. Of course, nucleotides labeled with a donor fluorophore also are useful in methods of the invention; FRET-based methods of the invention only require that a donor and acceptor fluorophore pair are used, a labeled nucleotide may comprise one fluorophore and either the template or the polymerase may comprise the other. Such labeling techniques result in a coincident fluorescent emission of the labels of the nucleotide and the labeled template or polymerase, or alternatively, the fluorescent emission of only one of the labels.

In a preferred embodiment, after detection, the label is rendered undetectable by removing the label from the nucleotide or extended primer, neutralizing the label, or masking the label. A cleavable link between the label and the nucleotide to which it is attached facilitates cleavage of the label once incorporation detection is accomplished. In particular, a disulfide link between nucleotide and label is of useful and is easily cleaved.

In certain embodiments, methods according to the invention provide for neutralizing a label by photobleaching. This is accomplished by focusing a laser with a short laser pulse, for example, for a short duration of time with increasing laser intensity. In other embodiments, a label is photocleaved. For example, a light-sensitive label bound to a nucleotide is photocleaved by focusing a particular wavelength of light on the label. Generally, it may be preferable to use lasers having different wavelengths for exciting and photocleaving. Labels also can be chemically cleaved. Labels may be removed from a substrate using reagents, such as NaOH or other appropriate buffer reagent.

Preferred substrates for deposition of a polyelectrolyte multilayer include glass, polished glass or silica. Examples of substrates appropriate for the invention also include polytetrafluoroethylene or a derivative of polytetrafluoroethylene, such as silanized polytetrafluoroethylene.

In a preferred embodiment, a polyelectrolyte multilayer is exposed to an amine-carboxyl cross-linker in the absence of biotin. In another embodiment, once the cross-linking is accomplished, the surface of the polyelectrolyte multilayer is coated with biotin and furthermore with avidin or streptavidin in order to create a surface for nucleic acid template attachment. In such an embodiment, the nucleic acid template is biotinylated and binds to an available binding site on the avidin or streptavidin molecule.

A detailed description of embodiments of the invention is provided below. Other embodiments of the invention are apparent upon review of the detailed description that follows.

### BRIEF DESCRIPTION OF THE DRAWINGS

FIG. 1 depicts a surface comprising a polyelectrolyte multilayer.

FIG. 2 shows experimental data from a polyelectrolyte multilayer cross-linking and biotin dye label challenge experiment.

FIG. 3 depicts a nucleic acid sequencing reaction on a cross-linked polyelectrolyte multilayer.

### DETAILED DESCRIPTION OF THE INVENTION

Single molecule sequencing allows one to obtain highly-sensitive sequence information that reflects individual genomic differences. Understanding genomic differences within and between individuals will lead to an understanding of both normal and pathological function. Methods and tools discussed herein provide optimal conditions for conducting single molecule sequencing reactions.

Single molecule sequencing benefits from accurate positional data for each target molecule attached to a substrate. It is also important to distinguish bound target from background. Accurate positional data largely is a function of surface stability; whereas background often depends upon how much non-specifically bound material adheres to the surface. The present invention addresses both of these issues by providing a highly wash-stable surface that has greatly reduced non-specific binding sites.

Polyelectrolyte multilayers are generally constructed through layer by layer deposition of oppositely charged electrolytic polymers on a surface. The layers maintain contact through electrostatic forces between alternating polycation and polyanion layers. When a polyelectrolyte multilayer is used as a surface for a nucleic acid sequencing reaction, it is advantageous to have the top layer be a polyanion layer (such as a carboxylic acid). The negative charge exhibited by this layer aids in numerous aspects of the sequencing reaction. For example, the negative charge facilitates attachment of amine groups or other molecules with a positive charge. Additionally, the negative charge repels bound nucleic acid templates from the surface so that they are conformationally available to bind a primer and nucleotide. To this end, the more negatively charged the surface, the more conformationally available the bound template becomes in order to facilitate incorporation of nucleotides during a step-wise sequencing reaction.

Many polyelectrolyte multilayers are unstable under common wash conditions. Thus, washing may shift the position of the multilayer, or may wash layers off the surface entirely. This results in a reduction in the ability to track the position of the various targets that have been attached to the surface. In addition, the negatively charged surface of a polyelectrolyte multilayer is available for non-specific binding, thus increasing background, for example, by creating fluorescence that obscures signal from a dye-labeled nucleotide. Non-specific binding may also increase the positive charge of the surface resulting in a detrimental effect on both primer binding and chain elongation.

Cross-linking the polyelectrolyte multilayer produces a number of beneficial effects that improve surface-bound nucleic acid sequencing. The net surface charge of the cross-linked surface is more negative than prior to cross-linking, which is a desirable trait that provides an appropriate platform for nucleic acid synthesis reactions. Additionally, because the top carboxyl layer of the polyelectrolyte multilayer is cross-linked, there are fewer sites available for non-specific binding of molecules. Finally, cross-linking the polyelectrolyte multilayer increases its stability, thus improving its wash stability.

Methods of the invention comprise introducing an amine-carboxyl cross-linker to a polyelectrolyte multilayer. As discussed above, a polyelectrolyte multilayer is built using alternating positively charged and negatively charged layers. The amine-carboxyl cross-linker binds the two layers together and thus, increases overall stability. Because many cross-linkers, such as EDC, are small molecules, they generally can bind multiple alternating layers in a stack, thus further strengthening the stability of the overall layers. Also, once the surface carboxyl layer of a polyelectrolyte multilayer is cross-linked, there are fewer available binding sites for non-specific binding during nucleic acid sequencing reactions, or any other reactions that may require a surface with reduced non-specific binding capabilities.

Ideally, in order for a substrate to be utilized as a platform for single molecule sequencing, defects that are responsible for the production of background that might interfere with detection of incorporated nucleotides should be removed. A cross-linked polyelectrolyte multilayer coated substrate provides substantial advantages for nucleic acid sequence determination and for polymerization reactions generally. First, a polyelectrolyte multilayer can easily be terminated with polymers bearing carboxylic acids, thereby facilitating nucleic acid attachment. Second, the attached nucleic acid molecule is available for extension by polymerases due to the repulsion of like charges between the negative carboxylic groups. Also, the negative polynucleotide backbone hinders the nucleic acid molecule from a formation that is substantially parallel to the surface of the substrate. In addition, the negative charges repel unincorporated nucleotides, thereby reducing nonspecific binding and hence background interference. Finally, cross-linking results in fewer reactive groups for covalent or non-covalent non-specific binding.

Polyelectrolyte multilayer formation proceeds by the sequential addition of polycations and polyanions, which are polymers with many positive or negative charges, respectively. Upon addition of a polycation to a negatively-charged surface, the polycation deposits on the surface, forming a thin polymer layer and reversing the surface charge. Similarly, a polyanion deposited on a positively charged surface forms a thin layer of polymer and leaves a negatively charged surface. Alternating exposure to poly(+) and poly(−) generates a polyelectrolyte multilayer structure with a surface charge determined by the last polyelectrolyte added. Decher et al., Build-Up of Ultra Thin Multilayer Films by a Self-Assembly Process, Thin Solid Films, 210:831-835, 1992. Poly electrolyte polymers include but are not limited to, Poly(Acrylic Acid) (PAcr), Poly Ethyleneimine (PEI), Poly Allylamine, Polystyrene Sulphonate (PSS), Polylysine, and Polyglutamic Acid. Other poly-electrolyte polymers known in the art are suitable for use with embodiments of the invention as well.

Substrates for use according to the invention can be two- or three-dimensional and can comprise a planar surface (e.g., a glass or silica slide) or can be shaped. A substrate can include glass (e.g., controlled pore glass (CPG)), quartz, plastic (such as polystyrene (low cross-linked and high cross-linked polystyrene), polycarbonate, polypropylene and poly(methymethacrylate)), acrylic copolymer, polyamide, silicon, metal (e.g., alkanethiolate-derivatized gold), cellulose, nylon, latex, dextran, gel matrix (e.g., silica gel), polyacrolein, or composites.

Preferably, a substrate used according to the invention includes a biocompatible or biologically inert material that is transparent to light and optically flat (i.e., with a minimal micro-roughness rating). Specially manufactured, or chemically derivatized, low background fluorescence substrates (e.g., glass or silica slides) are also contemplated according to the invention. Substrates may be prepared and analyzed on either the top or bottom surface of the planar substrate (i.e., relative to the orientation of the substrate in the detection system.)

Generally, a substrate may be of any suitable material that allows for single molecules to be individually optically resolvable.

The invention also includes three-dimensional substrates that include, for example, spheres, tubes (e.g., capillary tubes), microwells, microfluidic devices, or any other structure suitable for anchoring a nucleic acid. For example, a substrate can be a microparticle, a bead, a membrane, a slide, a plate, a micromachined chip, and the like. Substrates can include planar arrays or matrices capable of having regions that include populations of target nucleic acids or primers. Examples include nucleoside-derivatized CPG and polystyrene slides; derivatized magnetic slides; polystyrene grafted with polyethylene glycol; and the like.

Factors for selecting substrates include, for example, the material, porosity, size, and shape. In addition, substrates that can lower (or increase) steric hindrance of polymerase are preferred according to the invention. Other important factors to be considered in selecting appropriate substrates include size uniformity, efficiency as a synthesis support, and the substrate's optical properties, e.g., clear smooth substrates (free from defects) provide instrumentational advantages when detecting incorporation of nucleotides in single molecules (e.g., nucleic acids.).

A target nucleic acid for analysis may be obtained directly from a patient, e.g., from blood, urine, cerebrospinal fluid, seminal fluid, saliva, breast nipple aspirate, sputum, stool and biopsy tissue. Any tissue or body fluid specimen may be used according to methods of the invention.

A target nucleic acid can come from a variety of sources. For example, nucleic acids can be naturally occurring DNA or RNA isolated from any source, recombinant molecules, cDNA, or synthetic analogs, as known in the art. For example, the target nucleic acid may be genomic DNA, genes, gene fragments, exons, introns, regulatory elements (such as promoters, enhancers, initiation and termination regions, expression regulatory factors, expression controls, and other control regions), DNA comprising one or more single-nucleotide polymorphisms (SNPs), allelic variants, and other mutations. Also included is the full genome of one or more cells, for example cells from different stages of diseases such as cancer. The target nucleic acid may also be mRNA, tRNA, rRNA, ribozymes, splice variants, antisense RNA, and RNAi. Also contemplated according to the invention are RNA with a recognition site for binding a polymerase, transcripts of a single cell, organelle or microorganism, and all or portions of RNA complements of one or more cells, for example, cells from different stages of development or differentiation, and cells from different species. Nucleic acids can be obtained from any cell of a person, animal, plant, bacteria, or virus, including pathogenic microbes or other cellular organisms. Individual nucleic acids can be isolated for analysis.

Once a target is immobilized on the stabilized polyelectrolyte multilayer the target nucleic acid is hybridized to a primer to form a target nucleic acid-primer complex. Thereafter, primer extension is conducted to sequence the target nucleic acid or primer using a polymerase and a nucleotide (e.g., dATP, dTTP, dUTP, dCTP and/or a dGTP) or a nucleotide analog. Incorporation of a nucleotide or a nucleotide analog and their locations on the surface of a substrate are detected with single molecule sensitivity according to the invention. In some aspects of the invention, single molecule resolution is achieved by anchoring a target nucleic acid at a low concentration to a cross-linked polyelectrolyte multilayer, and then imaging nucleotide incorporation, for example, with total internal reflection fluorescence microscopy.

Certain embodiments of the invention are described in the following examples.

### EXAMPLES

### Example 1

### Cross-Linking a Polyelectrolyte Multilayer

Preparing a Polyelectrolyte Multilayer

Glass slides (Erie Scientific®, Portsmouth, N.H.) were sonicated for 30 minutes in a 2% solution of Micro-90 (Millipore®). The sonicated slides were then rinsed under a stream of MilliQ H₂O (Millipore®) for 8 minutes and transferred to a fume hood. Slides were then boiled in an RCA solution (6:4:1 MilliQ H₂O: NH₄OH (28%): H₂O₂ (30%)) at 60° C. for 90 minutes and rinsed under a stream of MilliQ H₂O. The slides were then transported to a clean air hood and covered until used.

Polyethyleneimine (PEI) and polyacrylic acid (PAA) (Sigma®) were separately dissolved by stirring 2 mg/ml in MilliQ H₂O. The pH was adjusted to 8.0 with dilute HCl and filtered through a 0.22μ filter flask. The solutions were stored at 4° C. Two crystallizing dishes were filled with 1 L each of either PEI or PAA. The RCA-cleaned slides described above were immersed in PEI for 10 minutes with no agitation, and rinsed as described above. The slides were then immersed in PAA and rinsed. The procedure described above for PEI/PAA immersion was repeated 3 additional times, after which slides were covered and stored in a clean air hood in MES buffer (2-[N-morpholino]ethanesulfonic acid), pH 5.5 overnight. The resulting slides contain a polyelectrolyte multilayer coating.

Crosslinking a Polyelectrolyte Multilayer

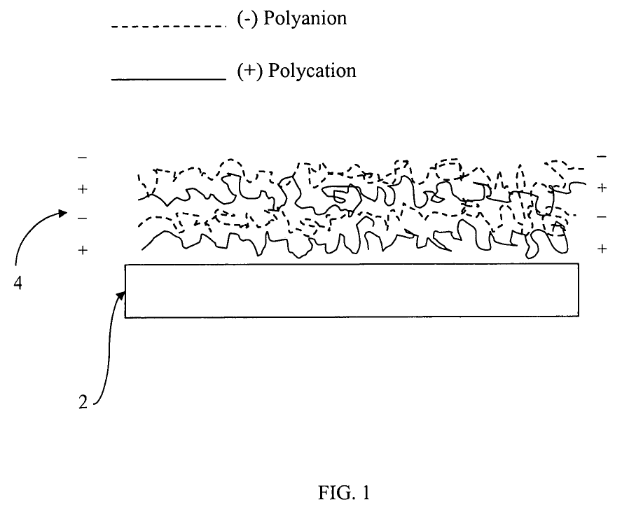

A 2.5 mM solution of 1-[3-(dimethylamino)propyl]-3-ethylcarbodiimide hydrochloride (EDC, Aldrich®) was prepared in MES buffer. The resulting solution was filtered and the polyelectrolyte multilayer-coated slides prepared as described above were incubated in the EDC solution for 2 hours at room temperature. The resulting cross-linked polyelectrolyte multilayer slides were rinsed in MES buffer and stored under a clean air hood in MES. An exemplary surface comprising a polyelectrolyte multilayer is shown in FIG. 1.

### Example 2

### Rinsability and Passivation of a Cross-Linked Polyelectrolyte Multilayer

An experiment was conducted to determine the rinsability and passivation of a cross-linked polyelectrolyte multilayer surface coating prepared as in Example 1. Four different polyelectrolyte multilayer surfaces were treated. First, a polyelectrolyte multilayer surface was prepared and treated with EDC for 30 minutes (90 mg/ml in MES buffer, pH 5.5). A second surface was prepared identical to the first, but was biotinylated after EDC treatment. A third surface was prepared identical to the first except that EDC treatment was conducted for 2 hours. Finally, a surface identical to the third surface was biotinylated after EDC treatment.

For each biotinylated surface, biotinylation was conducted as follows. A 50 mM EDC solution was prepared in MES buffer (48 mg of EDC in 2.5 ml MES buffer). A 5 ml aliquot of the EDC solution was then combined with biotin-LC-PEO amine solution (50 mg Biotin-Lc-PEO in 2.5 ml MES buffer) to make an EDC-biotin solution. The solution was diluted in MES buffer to a total volume of 96 ml. The polyelectrolyte multilayer coated slides were then immersed in the EDC-biotin solution in a 100 ml beaker for 60 minutes at room temperature. The slides were then rinsed in MES with gentle agitation for 10 seconds. The rinse was then repeated further with clean 100 ml volumes. The slides were then rinsed in 5 clean volumes of 3×SSC-0.1% triton buffer. Slides were incubated for 10 minutes in the final rinse with the 3×SSC-0.1% triton buffer. Finally, the slides were agitated in a 10 mM Tris-NaCl buffer (10 mM Tris-HCL/10 mM NaCl) for 10 minutes. The resulting slides had a uniform biotin layer.

A layer of streptavidin was next added to the slides. A 14 mg/ml solution of Streptavidin-Plus (SA20, Prozyme) was dissolved in 10 mM Tris/10 mM NaCl buffer by stirring for 10 minutes at room temperature. The solution was filtered with a 0.2 u filter. Biotinylated slides were immersed in the streptavidin solution in a 100 ml beaker and stirred using a stir bar for 15 minutes at room temperature. The slides were rinsed in 100 ml of the 10 mM Tris/10 mM NaCl buffer with gentle agitation for 10 seconds. Rinsing was then repeated in 5 clean 100 ml volumes of 3×SSC-0.1% Triton, allowing the slides to incubate in the final solution for 10 minutes. The slides were then transferred to a fresh bath of 10 mM Tris-NaCl and agitated for 10 seconds. The resulting streptavidinated slides were stored submerged in 10 mM Tris-NaCl at 4° C. prior to use.

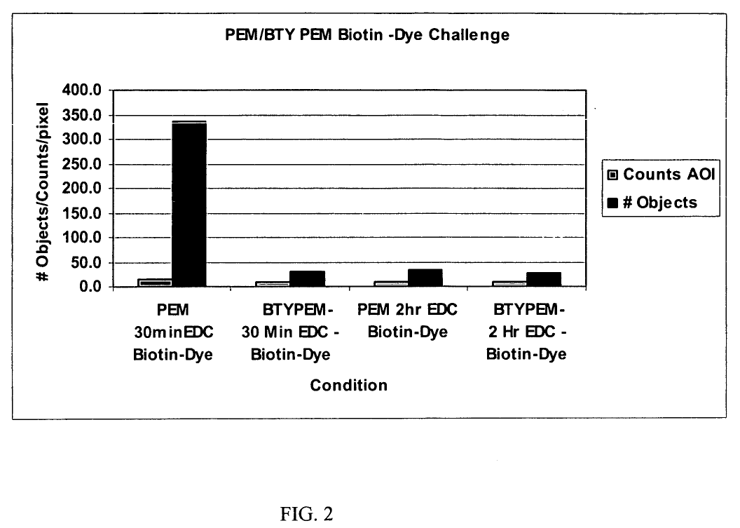

Each of the four surfaces created was challenged by incubation for 5 minutes at room temperature in 200 nM dye 547-biotin. After incubation, the surfaces were rinsed in 10 mM tris-10 mM NaCl, pH 8.0. That was followed by 5 changes in 3×SSC-0.1% Triton buffer, with a 10 minute incubation in the final change. The surfaces were then rinsed in 10 mM Tris-10 mM NaCl and were wet mounted in the Tris/NaCl solution for imaging. Slides were analyzed under microscopy using total internal reflection illumination. The image data are shown in FIG. 2.

As shown in FIG. 2, the surface with 30 minutes EDC and no biotin, retained the largest number of objects, indicating poor rinsability. Both biotinylated surfaces had low numbers of objects, indicating that biotin exposure, EDC cross-linking, or both, passivated the surface. Finally, the surface that was incubated in EDC for 2 hours had a low number of objects. That surface had no biotin exposure. These data indicate that good surface rinsability is due to EDC-involved cross-linking and not to biotin addition to the surface.

### Example 3

### Sequencing a Target Nucleic Acid on a Cross-Linked Polyelectrolyte Multilayer Platform

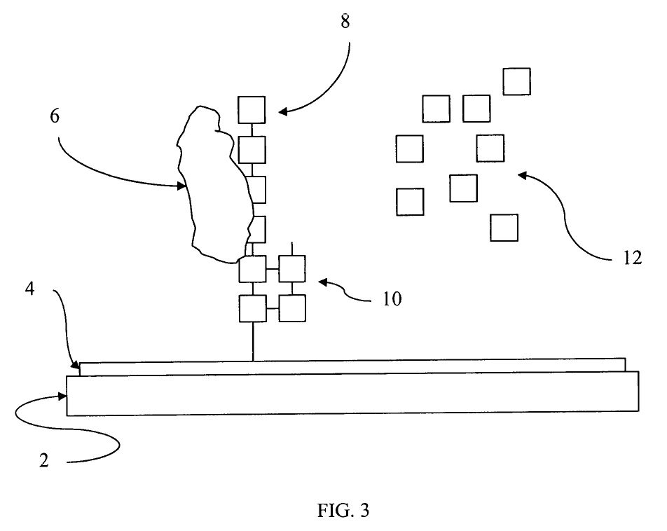

FIG. 3 is a diagram of a nucleic acid sequencing reaction performed on a stabilized polyelectrolyte multilayer. A single strand of nucleic acid (8) is attached to a stabilized polyelectrolyte multilayer (4) on the surface of a substrate (2). The primer (10) may be attached before or after attachment of the template (8) to the stabilized polyelectrolyte multilayer (4). Polymerase (6) directs the template dependent attachment of nucleotides (12) in sequential manner in order to determine the sequence of the template (8).

Preparing the Template

A cross-linked polyelectrolyte multilayer platform is produced as in Example 1 using EDC or other amine-carboxyl reactive cross-linkers, with a negatively charged carboxyl layer comprising the surface or top layer. The target nucleic acid is then attached to the polyelectrolyte multilayer in any number of ways. The immobilization can be achieved through direct or indirect binding of the templates to the surface or by attaching a primer specific for a known sequence on the template to the surface. The binding can be by covalent linkage. See, Joos et al., Analytical Biochemistry 247:96-101, 1997; Oroskar et al., Clin. Chem 42:1547-1555, 1996; and Khandjian, Mole. Bio. Rep. 11:107-115, 1986. The bonding can also be through non-covalent linkage. For example, biotin-streptavidin (Taylor et al., J. Phys. D. Appl. Phys. 24:1443, 1991) and digoxigenin and anti-digoxigenin (Smith et al., Science 253: 1122, 1992) are common tools for attaching polynucleotides to surfaces and parallels.

Primer Attachment to the Template

Sequencing a target nucleic acid by synthesizing its complementary strand can include the step of hybridizing a primer to the target nucleic acid. Primer length can be selected to facilitate hybridization to a sufficiently complementary region of the template nucleic acid downstream of the region to be analyzed. The exact lengths of the primers depend on many factors, including temperature and source of primer.

If part of the region downstream of the sequence to be analyzed is known, a specific primer can be constructed and hybridized to this region of the target nucleic acid. Alternatively, if sequences of the downstream region on the target nucleic acid are not known, universal (e.g., uniform) or random primers may be used in random primer combinations. As another approach, a linker or adaptor can be joined to the ends of a target nucleic acid polynucleotide by a ligase and primers can be designed to bind to these adaptors. That is, a linker or adaptor can be ligated to at least one target nucleic acid of unknown sequence to allow for primer hybridization. Alternatively, known sequences may be biotinylated and ligated to the targets. In yet another approach, nucleic acid may be digested with a restriction endonuclease, and primers designed to hybridize with the known restriction sites that define the ends of the fragments produced.

Primers can be synthetically made using conventional nucleic acid synthesis techniques. For example, primers can be synthesized on an automated DNA synthesizer, e.g. an Applied Biosystems, Inc. (Foster City, Calif.) model 392 or 394 DNA/RNA Synthesizer, using standard chemistries, such as phosphoramidite chemistry, and the like. Alternative chemistries, e.g., resulting in non-natural backbone groups, such as phosphorothioate, phosphoramidate, and the like, may also be employed provided that, for example, the resulting oligonucleotides are compatible with the polymerizing agent. The primers also can be ordered commercially from a variety of companies which specialize in custom nucleic acids such as Operon, Inc. (Alameda, Calif.).

The primer can be hybridized to the target nucleic acid before or after it is linked on a surface of a substrate or array. Primer annealing can be performed under conditions which are stringent enough to require sufficient sequence specificity, yet permissive enough to allow formation of stable hybrids at an acceptable rate. The temperature and time required for primer annealing depend upon several factors including base composition, length, and concentration of the primer; the nature of the solvent used, e.g., the concentration of DMSO, formamide, or glycerol; as well as the concentrations of counter ions, such as magnesium. Typically, hybridization with synthetic polynucleotides is carried out at a temperature that is approximately 5° C. to approximately 10° C. below the melting temperature (Tm) of the target polynucleotide-primer complex in the annealing solvent. However, according to methods of the invention, hybridization may be performed at much lower temperatures, such as for example 30-50° C. or 30-40° C. The annealing reaction can be complete within a few seconds.

Detecting Incorporation of a Nucleotide

The primer selected to attach to the template can also include a detectable label. When hybridized to a nucleic acid molecule, the label facilitates locating the bound molecule through imaging. The primer can be labeled with a fluorescent labeling moiety (e.g., Cy3 or Cy5), or any other means used to label nucleotides. The detectable label used to label the primer can be different from the label used on the nucleotides or nucleotide analogs in the subsequent extension reactions. Additionally, it may be desirable to render the detectable label undetectable prior to repeated detection steps by methods such as washing or photobleaching. Finally, the template itself may also have a detectable label.

Suitable fluorescent labels include, but are not limited to, 4-acetamido-4′-isothiocyanatostilbene-2,2′disulfonic acid; acridine and derivatives: acridine, acridine isothiocyanate; 5-(2′-aminoethyl)aminonaphthalene-1-sulfonic acid (EDANS); 4-amino-N-[3-vinylsulfonyl)phenyl]naphthalimide-3,5 disulfonate; N-(4-anilino-1-naphthyl)maleimide; anthranilamide; BODIPY; Brilliant Yellow; coumarin and derivatives; coumarin, 7-amino-4-methylcoumarin (AMC, Coumarin 120), 7-amino-4-trifluoromethylcouluarin (Coumaran 151); cyanine dyes; cyanosine; 4′,6-diaminidino-2-phenylindole (DAPI); 5′5″-dibromopyrogallol-sulfonaphthalein (Bromopyrogallol Red); 7-diethylamino-3-(4′-isothiocyanatophenyl)-4-methylcoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansylchloride); 4-dimethylaminophenylazophenyl-4′-isothiocyanate (DABITC); eosin and derivatives; eosin, eosin isothiocyanate, erythrosin and derivatives; erythrosin B, erythrosin, isothiocyanate; ethidium; fluorescein and derivatives; 5-carboxyfluorescein (FAM), 5-(4,6-dichlorotriazin-2-yl)aminofluorescein (DTAF), 2′,7′-dimethoxy-4′5′-dichloro-6-carboxyfluorescein (JOE), fluorescein, fluorescein isothiocyanate, QFITC, (XRITC); fluorescamine; IR144; IR1446; Malachite Green isothiocyanate; 4-methylumbelliferoneortho cresolphthalein; nitrotyrosine; pararosaniline; Phenol Red; B-phycoerythrin; o-phthaldialdehyde; pyrene and derivatives: pyrene, pyrene butyrate, succinimidyl 1-pyrene; butyrate quantum dots; Reactive Red 4 (Cibacron™ Brilliant Red 3B-A) rhodamine and derivatives: 6-carboxy-X-rhodamine (ROX), 6-carboxyrhodamine (R6G), lissamine rhodamine B sulfonyl chloride rhodarnine (Rhod), rhodamine B, rhodamine 123, rhodamine X isothiocyanate, sulforhodamine B, sulforhodamine 101, sulfonyl chloride derivative of sulforhodamine 101 (Texas Red); N,N,N′,N′tetramethyl-6-carboxyrhodamine (TAMRA); tetramethyl rhodamine; tetramethyl rhodamine isothiocyanate (TRITC); riboflavin; rosolic acid; terbium chelate derivatives; Cy3; Cy5; Cy5.5; Cy7; IRD 700; IRD 800; La Jolta Blue; phthalo cyanine; and naphthalo cyanine.

Depending on the characteristics of the target template, a DNA polymerase, a RNA polymerase, or a reverse transcriptase can be used in the primer extension reactions. The incorporation of the labeled nucleotide or nucleotide analog then can be detected on the primer. A number of systems are available to detect this incorporation. Methods for visualizing single molecules of labeled nucleotides with an intercalating dye include, e.g., fluorescence microscopy. In some embodiments, the fluorescent spectrum and lifetime of a single molecule excited-state can be measured. Standard detectors such as a photomultiplier tube or avalanche photodiode can be used. Full field imaging with a two-stage image intensified charged couple device (CCD) camera can also used. Additionally, low noise cooled CCD can also be used to detect single fluorescent molecules.

The detection system for the signal may depend upon the labeling moiety used, which can be defined by the chemistry available. For optical signals, a combination of an optical fiber or CCD can be used in the detection step. In the embodiments where the substrate is itself transparent to the radiation used, it is possible to have an incident light beam pass through the substrate with the detector located opposite the substrate from the primer. For electromagnetic labels, various forms of spectroscopy systems can be used. Various physical orientations for the detection system are available and known in the art.

A number of approaches can be used to detect incorporation of fluorescently-labeled nucleotides into a single molecule. Optical systems include near-field scanning microscopy, far-field confocal microscopy, wide-field epi-illumination, light scattering, dark field microscopy, photoconversion, single and/or multiphoton excitation, spectral wavelength discrimination, fluorophore identification, evanescent wave illumination, and total internal reflection fluorescence (TIRF) microscopy. In general, methods involve detection of laser-activated fluorescence using a microscope equipped with a camera, sometimes referred to as high-efficiency photon detection system. Suitable photon detection systems include, but are not limited to, photodiodes and intensified CCD cameras. For example, an intensified charge couple device (ICCD) camera can be used. The use of an ICCD camera to image individual fluorescent dye molecules in a fluid near a surface provides numerous advantages. For example, with an ICCD optical setup, it is possible to acquire a sequence of images (movies) of fluorophores.

FRET Labeling Methods

Nucleotide donor/acceptor. Using FRET detection, a primer is bound to a detectable label such as Cy3. The primer is selected to bind to the template nucleic acid that is attached to a surface. The surface is then washed and the positions of the Cy3-primed templates are recorded and bleached. Next, a Cy3 labeled nucleic acid and polymerase are introduced under optimal nucleic acid sequencing condition and the surface is washed. An image of the surface is then detected for incorporation of labeled nucleic acid. If there is no incorporation, the procedure is repeated with another nucleotide until a Cy3 labeled base incorporation onto the primer is detected. Once a Cy3 labeled nucleotide is detected, the label remains unbleached and the extension reaction is carried out in the presence of a Cy5 labeled nucleotide. After washing, an incorporation of a Cy5 labeled nucleotide results in an optically detectable event as the Cy5 label acts as an acceptor fluorophore from nearby Cy3 donor fluorophore. Subsequent to a Cy5 acceptor detection, the mixture is photobleached such that incorporation of another Cy5 labeled nucleotide is now detectable during subsequent extension reactions.

Polymerase donor. In this method, the polymerase comprises a donor fluorophore and the labeled nucleotides comprise an acceptor fluorophore. Incorporation of a labeled nucleotide into the growing primer strand is visible during the detection phase of the reaction when a photon is transferred from the donor polymerase.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. A method for stabilizing a polyelectrolyte multilayer on a substrate, the method comprising the step of:
exposing a surface comprising a polyelectrolyte multilayer to an amine-carboxyl reactive cross-linker such that said cross-linker stabilizes said polyelectrolyte multilayer on said surface.

2. The method of claim 1, wherein said amine-carboxyl cross-linker is an EDC [1-Ethyl-3(3-Dimethylaminopropyl)carbodiimide Hydrochloride].

3. The method of claim 1, wherein said polyelectrolyte multilayer comprises a poly-electrolyte polymer selected from the group consisting of Poly(Acrylic Acid) (PAcr), Poly Ethyleneimine (PEI), Poly Allylamine, Polystyrene Sulphonate (PSS), Polylysine, and Polyglutamic Acid.

4. The method of claim 1, wherein said exposing step includes cross-linking said plurality with ultraviolet cross-linking.

5. The method of claim 1, wherein said exposing step includes cross-linking said plurality with dehydration cross-linking.

6. The method of claim 1, wherein said exposing step increases the negative surface charge of the polyelectrolyte multilayer.

7. The method of claim 1, wherein said exposing step decreases the number of non-specific binding sites on said substrate.

8. The method of claim 1, further comprising the step of exposing a nucleic acid template to said substrate.

9. The method of claim 1, wherein said cross-linked polyelectrolyte multilayer comprises a biotin molecule.

10. The method of claim 8, further comprising the step of exposing a streptavidin molecule or an avidin molecule and a nucleic acid template to said substrate.

11. The method of claim 10, wherein said nucleic acid template is biotinylated.

12. The method of claims 8 or 10, wherein said template is individually optically resolvable on said substrate.

12. The method of claim 8, further comprising the step of exposing a polymerase, a primer, and at least one nucleotide capable of extension into said primer, to said template.

13. The method of claim 12, further comprising the step of detecting the incorporation of said nucleotide into said primer.

14. The method of claim 13, wherein said exposing and said detecting steps are repeated at least once, in order to compile a sequence of said primer based upon an order of incorporated nucleotides.

15. The method of claim 13, wherein said primer comprises a detectable label.

16. The method of claim 13, wherein said template comprises a detectable label.

17. The method of claim 15 or 16, wherein said detectable label is rendered undetectable prior to said exposing step.

18. The method of claim 15, wherein said primer comprises a first detectable label and said nucleotide comprises a second detectable label.

19. The method of claim 18, wherein said detectable labels are fluorescent labels.

20. The method of claim 18, wherein the incorporation of said nucleotide results in an optically detectable event resulting from an interaction between said first detectable label and said second detectable label.

21. The method of claim 20, wherein said detectable labels are rendered undetectable prior to repeating said exposing step.

22. A method for stabilizing a polyelectrolyte multilayer on a substrate, the method comprising the step of:
exposing a surface comprising a polyelectrolyte multilayer, said surface further comprising a substantial absence of biotin molecules, to an amine-carboxyl reactive cross-linker such that said cross-linker said polyelectrolyte multilayer on the substrate.

23. A method for sequencing a nucleic acid, the method comprising the steps of:
(a) exposing a surface comprising a polyelectrolyte multilayer to an amine-carboxyl reactive cross-linker such that said cross-linker said polyelectrolyte multilayer on the substrate;
(b) exposing said surface to a nucleic acid template;
(c) exposing said template to a primer, a polymerase, and at least one nucleotide under conditions that allow for incorporation of said nucleotide into said primer;
(d) detecting incorporation of said nucleotide into said primer;
(e) repeating steps (c) and (d) at least once; and
(f) compiling a sequence of said template.

24. The method of claim 1, wherein said template is attached to said substrate such that it is individually optically resolvable.

25. The method of claim 1, wherein said polyelectrolyte multilayer comprises a substantial absence of biotin molecules.

26. The method of claim 1, further comprising the step of coating said polyelectrolyte multilayer with biotin.

27. The method of claim 1, further comprising the step of exposing said polyelectrolyte multilayer to an avidin molecule or a streptavidin molecule.

28. The method of claim 1, wherein said template is biotinylated.

29. The method of claim 2, wherein said primer comprises a first detectable label and said nucleotide comprises a second detectable label.

30. The method of claim 3, wherein said detectable labels are fluorescent labels.

31. The method of claim 8, wherein the incorporation of said nucleotide results in an optically detectable event resulting from an interaction between said first detectable label and said second detectable label.

32. The method of claim 9, wherein said detectable labels are rendered undetectable prior to repeating said repeating step.

33. The method of claim 1, wherein said substrate is selected from the group consisting of a glass, a plastic, a membrane, or a gel.

34. The method of claim 1, wherein said polyelectrolyte multilayer comprises a poly-electrolyte polymer selected from the group consisting of Poly(Acrylic Acid) (PAcr), Poly Ethyleneimine (PEI), Poly Allylamine, Polystyrene Sulphonate (PSS), Polylysine, and Polyglutamic Acid.

35. The method of claim 1, wherein said amine-carboxyl cross-linker is an EDC [1-Ethyl-3(3-Dimethylaminopropyl)carbodiimide Hydrochloride].
